(19) United States
(12) Patent Application Publication
(10) Pub. No.: US 2012/0272636 A1
(43) Pub. Date: Nov. 1, 2012

(54) COMBUSTOR DRAIN VALVE AND ASSEMBLY

(75) Inventor: Senol Guclucan, South Windsor, CT (US)

(73) Assignee: HAMILTON SUNDSTRAND CORPORATION, Windsor Locks, CT (US)

(21) Appl. No.: 13/098,021

(22) Filed: Apr. 29, 2011

(51) Int. Cl. F02G 3/00

(52) U.S. Cl. 60/39.094

(57) ABSTRACT

A valve assembly comprises a housing, a movable member, a fixed member, and a resilient member. The seat element has an upstream side, a downstream side, and an outlet port providing fluid communication therebetween, with the seat element fixed in a flow control segment adjacent a valve outlet. The drain element, operable between a first axial position closest to an inlet structure, and a second axial position abutting an upstream surface of the fixed seat element, is retained upstream from the fixed seat element and includes an upstream side, a downstream side, and a plurality of inlet ports through the drain element providing fluid communication therebetween. The resilient element is disposed axially within a middle fluid chamber defined by a portion of the flow control segment located between the fixed seat element and the movable drain element, the resilient element applying a first biasing force to urge the drain element upstream toward the first position, urging the valve into an open, flow permissive configuration.

### BACKGROUND

The combustor of a gas turbine engine ignites fuel mixed with compressed air in one or more combustion chambers, and maintains controlled burning of the air-fuel mixture. The combustion products are directed into the turbine section, where it is then exhausted through a nozzle or pipe to drive one or more turbine stages. To ensure rapid and reliable startup, the combustor chamber(s) must be vented or drained of unburned fuel. Unburned fuel can accumulate in the combustor before or after operation due to minor leaks from fuel lines, failed starts, and the like. At the same time, it is desirable that any vent or drain minimize or prevent compressed air from escaping during engine operation.

To address this issue, combustors typically include a drain valve downstream from the combustor chamber(s) to direct excess liquid to an overboard drain. The drain valve permits flow when the engine is not operating, and restricts flow when the engine is active. Current drain valves are subject to jamming and premature failure, leading to bleeding of compressor air overboard during engine operation and incomplete drainage when the engine is offline. This complicates the ability to build an efficient and fail resistant valve.

### SUMMARY

A valve assembly comprises a housing, a movable member, a fixed member, and a resilient member. The housing includes a central bore extending through the housing with a central flow control segment disposed axially between an inlet fitting segment and an outlet fitting segment. The seat element has an upstream side, a downstream side, and an outlet port proximate a center of the seat element providing fluid communication therebetween, with the seat element fixed in the flow control segment adjacent the outlet fitting segment. The drain element is retained upstream from the fixed seat element and includes an upstream side, a downstream side, and a plurality of inlet ports through the drain element providing fluid communication therebetween. The drain element is operable between a first axial position closest to the inlet fitting segment, and a second axial position abutting an upstream surface of the fixed seat element, with the first axial position defining a first, flow-permissive configuration for the valve assembly, and the second axial position defining a flow-restrictive configuration for the valve assembly. The resilient element is disposed axially within a middle fluid chamber defined by a portion of the flow control segment located between the fixed seat element and the movable drain element, the resilient element applying a first biasing force to urge the drain element upstream toward the first position, urging the valve into the open, flow permissive configuration.

A valve drain element comprises a drain element body, a bias receiving surface, a recessed structure, and a fluid isolation structure. The substantially cylindrical body is configured for axial movement along a valve bore between a first upstream position and a second downstream position. The body includes an upstream side, a downstream side, and a plurality of ports providing fluid communication therebetween. The body is sized to direct fluid flow exclusively through the plurality of ports instead of around an outer diameter of the drain element. The bias receiving surface forms a portion of the downstream side of the body, and is configured to axially direct a first applied biasing force urging the drain element toward the first upstream position. The recessed structure on the upstream side of the body is configured to concentrate and direct fluid pressure received from an upstream source into a second biasing force opposing the first biasing force. The fluid isolating structure projects generally perpendicular to the body from the downstream side and is configured to abut a second fluid isolating structure when the drain element is in the second downstream position.

### BRIEF DESCRIPTION OF THE DRAWINGS

FIG. 1A schematically depicts a perspective cross-section of a combustor drain valve in an open configuration.

FIG. 1B is a perspective cross-section of the combustor drain valve in a closed configuration.

FIG. 2 is a plan cross-section of the combustor drain valve housing.

FIG. 3A depicts a perspective view of a movable drain element.

FIG. 3B is a plan cross-section of the movable drain element from FIG. 3A

FIG. 4A shows a perspective view of a fixed valve seat element.

FIG. 4B is a plan cross-section of the fixed valve seat element from FIG. 4A.

### DETAILED DESCRIPTION

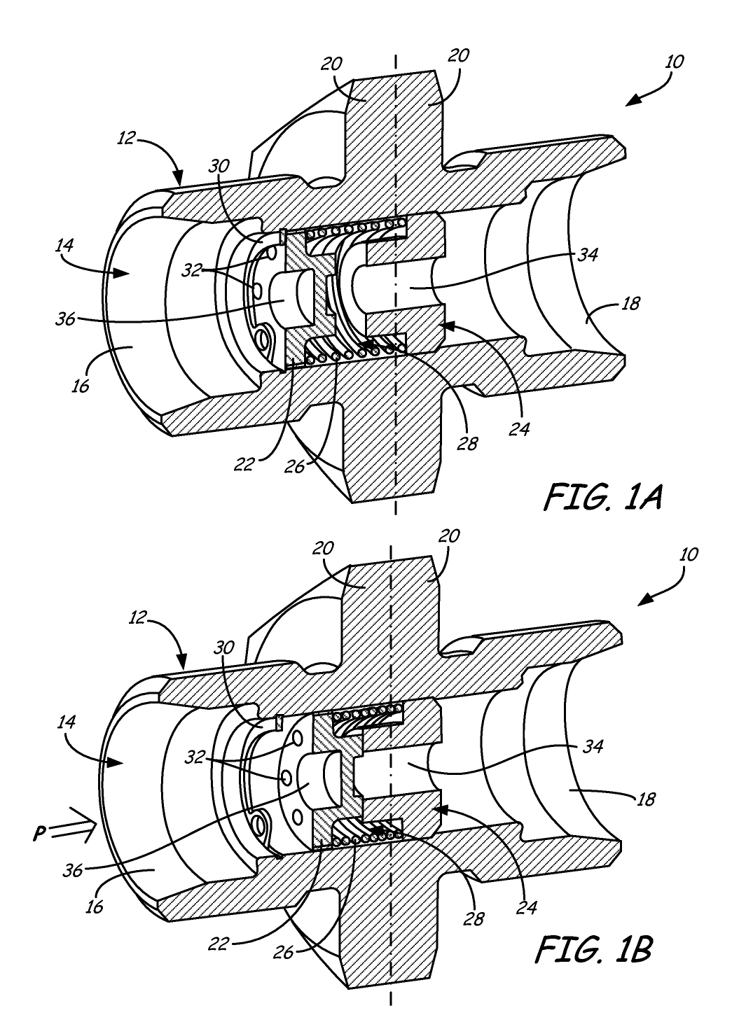

FIGS. 1A and 1B show perspective cross-sections of a combustor drain valve 10 in respective open (drain) and closed (sealed) positions. The valve 10 includes housing 12, bore 14, valve inlet section 16, valve outlet section 18, connecting flanges 20, movable drain element 22, fixed valve seat element 24, resilient spring element 26, middle chamber 28, retaining ring 30, drain element ports 32, valve seat port 34, and drain element recess 36.

Combustor drain valve 10 regulates drainage of excess unburned fuel from a combustor of a gas turbine engine (not shown). The operation of gas turbine engines are well known, with the combustor section being disposed between a compressor section and a turbine section. The gas turbine engine, for example, can be an industrial gas turbine or can be secured to an aircraft either to provide motive power or to provide supplemental electric, hydraulic, or pneumatic power as an auxiliary power unit (APU).

During startup or shutdown, or even occasionally while the engine is wholly inactive, excess fuel can accumulate in the combustor which must be drained to ensure safe starts and prevent fires. Fuel can build up in the combustor chambers for several reasons including failed starts, small leaks from fuel control valves, etc. Valve 10 is thus configured in FIG. 1A to drain this excess fuel when the engine is off. Valve 10 is automatically closed when combustion chambers are pressurized to prevent loss of compressed air and fuel during engine operation. This configuration is shown in FIG. 1B.

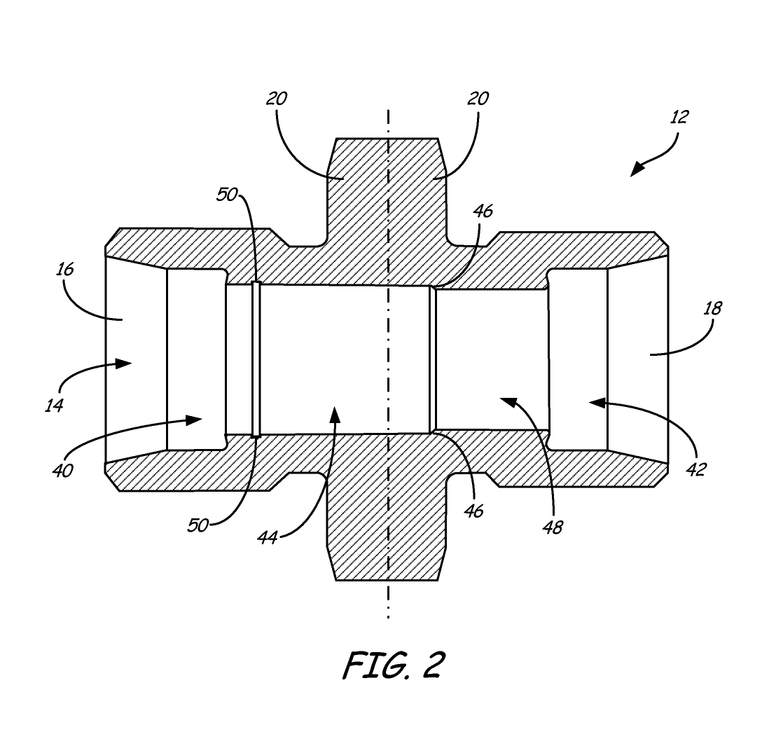

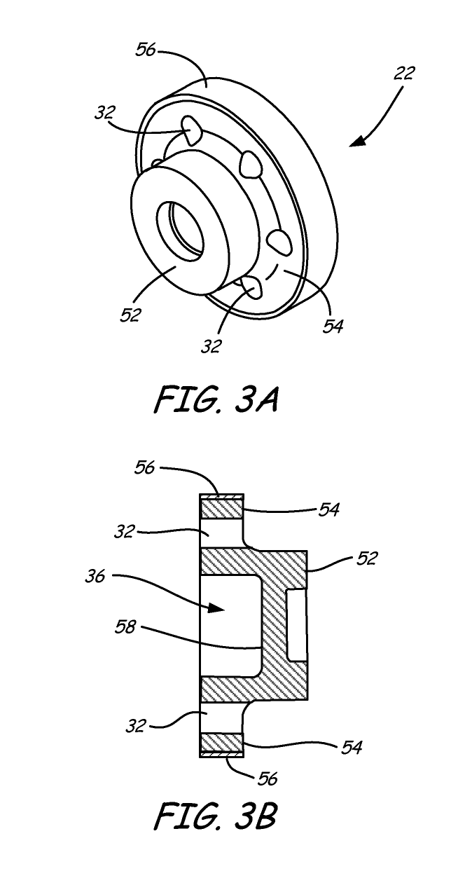

FIG. 1A shows drain valve 10 in an open (drain) configuration with housing 12 and bore 14. Inlet section 16 and outlet section 18 are bolted or otherwise secured together at flanges 20. Unburned fuel flows from the combustor chambers (not shown) into inlet section 16. When valve 10 is in this open position, there is free communication between inlet section 16 and outlet section 18 via the operative section containing movable drain element 22, fixed valve seat 24, and resilient element 26 (shown in more detail in FIGS. 3A and 3B). Resilient element 26, such as a spring, is disposed in middle chamber 28 and biases movable element 22 away from valve seat 24 and toward inlet section 16. Valve seat 24 is held in place by a seat or recess in an operative section of bore 14. Movable drain element 22 is prevented from being pushed out of bore 14 by retaining ring 30, which is elastically or resiliently retained in a groove or other structure formed out of bore 14. For example, retaining ring 30 is a ring or coil manufactured from resilient material similar to a spring like resilient element 26. With this material, ring 30 tends to expand to a larger diameter in the absence of an applied force. Ring 30 is then installed by bending it such that the diameter is temporarily reduced, then when the bending force is removed, the resilient material reacts and expands against the outer diameter of bore 14. As shown in FIG. 2, bore 14 can include a seat or recess to fix the axial position of retaining ring 30.

When inlet section 16 is not pressurized, there is no force to counter resilient element 26, and thus movable drain element remains on the inlet side of valve 10 away from seat element 24. Excess unburned fuel and potentially other fluids from the combustion chambers (not shown) are free to enter valve 10 via connection lines (not shown) leading to inlet 16. This fluid then flows through bore 14 into middle chamber 28 via drain ports 32 extending axially through movable drain element 22. The fluid is directed by the shape of drain ports 32, which can also be tapered radially toward the center line of bore 14 to further facilitate drainage toward valve seat port 34 where the fluid eventually exits from outlet section 18. Outlet section 18 typically includes fittings for connection to an overboard drain, but outlet 18 can alternatively lead to a fuel recovery system or similar apparatus (not shown).

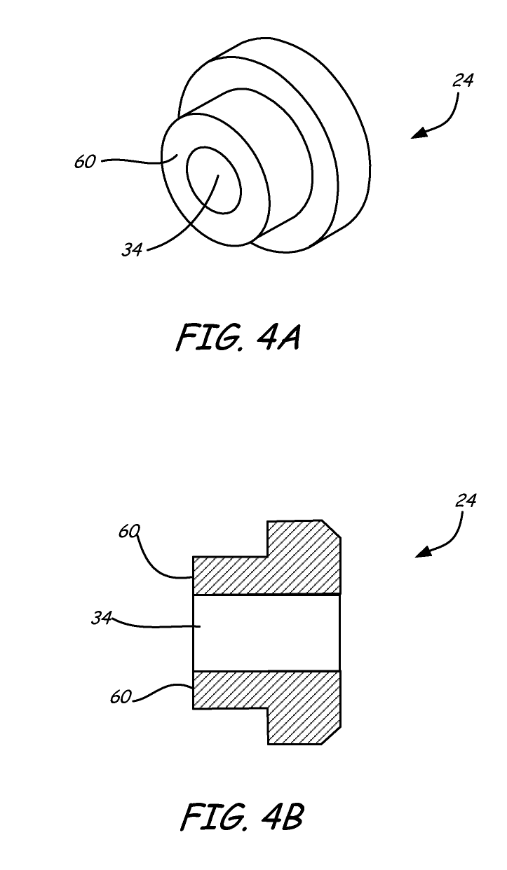

FIG. 1B shows drain valve 10 in a closed (sealed) position. Valve 10 is closed when inlet section 16 is pressurized. Pressure, represented by arrow P, comes from combustor chambers (not shown) containing the pressurized air-fuel mixture. In FIG. 1A, valve 10 was open due to resilient element 26 biasing movable drain element 22 away from valve seat 24. Here, pressure P is applied to drain element recess 36, which concentrates the force of pressure P over a smaller surface to oppose the biasing force of resilient spring element 26, urging movable drain element 22 to abut valve seat element 24. In this closed configuration of FIG. 1B, contents of the combustor chamber are no longer free to escape via drain ports 32 and valve seat port 34. Middle chamber 28 is now much smaller than was seen in FIG. 1A, and access to outlet section 18 via valve seat port 34 is blocked by contact between surfaces of movable drain element 22 and valve seat 24. Drain element 22 and valve seat 24 are shown in more detail in FIGS. 3A-4B.

Traditional drain valves utilize a ball-and-spring configuration to transition between open and closed configurations. In these prior valves, a spring is held between a pin at the inlet end and a valve seat at the outlet end of a bore with ball sitting at the inlet end of the spring adjacent the pin. During a non-operating condition, the combustor chamber(s) are unpressurized and the spring is intended to bias the ball against the pin to keep the valve open. Excess liquid and vaporized fuel then is to flow around the ball and out through the valve seat out of the bore. When the chamber is pressurized, the ball is to overcome the force of the spring to contact the seat blocking outlet flow.

The old ball-and-spring style valve tends to have several failure modes, making it prone to premature wear and failure. Repeated engine cycles impart fatigue stresses on the spring, extending the length of the spring and reducing the biasing force holding open the valve. The spring then works its way out of the bore, or otherwise gets displaced and causes a jam. With the ball more likely to get caught up in the center of the spring, eventually the biasing force that previously pushed the ball back in its proper position against the pin as inlet pressure approached zero is lost. The ball can also become jammed inside the center of the spring after being weakened from fatigue. This phenomenon is referred to as “ball stacking”.

Valve failure due to ball stacking allows compressed air to bleed out of the combustion chambers rather than being sealed off. This reduces available operating pressure and wastes fuel from reduced engine efficiency. Jamming of the valve in this manner renders it inoperable. In many cases, the old style valve can jam to such an extent that it will never completely open or close, leaving it permanently in a partially open state. The jammed valve cannot properly close because the ball is not in a place to react the compressed air from the inlet side of the valve, which flows around the ball as if the valve were open. When the prior art valve is stuck open, a fraction of the pressurized fuel-air mixture escapes the combustor through the jammed valve reducing efficiency from lost compressor work, fuel, and combustion energy.

In contrast, movable drain element 22 of valve 10 prevents ball stacking by providing a rigid perpendicular structure onto which resilient spring element 26 can exert its biasing force toward inlet section 16. Drain element 22 is sized to fit securely in bore 14 and includes a surface on the downstream side to prevent resilient element 26 from settling or slipping around the outer diameter of drain element 22. The biasing force on drain element 22 in turn urges valve 10 toward the open position shown in FIG. 1A. Thus, instead of the unburned fuel flowing around the outside of a ball, in valve 10 fluid travels through drain ports 32 into middle chamber 28, and then out through valve seat 24 via center port 34. Any liquid remaining in chamber 28 that does not immediately reach port 34 is eventually vaporized either by ambient conditions or by hot pressurized air from the operating combustor and eventually leaves chamber 28 through center port 34.

To maintain freedom of movement in bore 14, movable drain element 22 can be periodically lubricated or include a self-lubricating seal, gasket, or other similar structure around its outer diameter. Alternatively or additionally, bore 14 can include a self-lubricating coating. One suitable material for lubricating the outer diameter of drain element 22 includes graphite. However, many other coatings and/or lubricants can be selected to adapt this type of valve to other applications depending on particular thermal, mechanical, and chemical compatibilities.

Since it is much less likely for drain element 22 to jam or stick in resilient element 26 as compared to the prior ball-and-spring design, resilient spring element 26 can thus be stronger as compared to the prior design as well. This can extend the life of valve 10 because the risk of a stronger spring element 26 creeping or working its way out from behind movable drain element 22 is virtually nil, which minimizes the chances for valve 10 to jam and fail open.

Resilient element 26 in this example is a coil spring manufactured from X-750 nickel alloy, widely available from a number of commercial vendors. However, resilient element 26 can take other forms that provide a biasing force against drain element 22 and can withstand the chemical and thermal stresses inherent in a combustor assembly while still maintaining its required mechanical properties. If valve 10 is adapted to another purpose, resilient element 26 will, of course, be modified to account for the correspondingly different severity of service.

FIG. 2 shows the cross-section of valve housing 12 with bore 14, inlet section 16, outlet section 18, flanges 20, inlet fitting end 40, outlet fitting end 42, valve seat stage 44, shoulder 46, drain element stage 48, and ring groove 50.

Valve housing 12 is oriented vertically in FIG. 2 proximate the base of the combustor so as to facilitate drainage of unburned fuel mainly by gravity. Inlet section 16 and outlet section 18 each have respective fitting ends 40, 42 with relatively large internal diameters for coupling valve housing 12 to combustor chamber(s) and overboard drains (not shown).

As described above, inlet section 16 and outlet section 18 are joined and secured together at flanges 20 to form housing 12 with continuous bore 14. Bore 14 is machined with multiple sections or stages between fitting ends 40, 42 to facilitate installation and retention of the internal components. Furthest downstream and adjacent to outlet fitting end 42 is valve seat stage 44 and shoulder 46. Together they are shaped with substantially the same height and outer diameter to receive and retain valve seat 24. Stage 44 may be formed with a slightly larger diameter, however, to accommodate a seal between the outer diameter of seat 24 and the surface of stage 46. Drain element stage 48 is upstream of stage 44 and has a slightly larger diameter to retain and accommodate axial movement of resilient element 26 and drain element 22, which opens and closes the valve as shown in FIGS. 1A and 1B. Finally, stage 48 also includes a larger diameter groove 50 to hold retaining ring 30, also shown in FIGS. 1A and 1B. In this example, ring 30 is manufactured with a resilient material similar to a spring (like resilient member 26) such that it tends to bias itself radially outward. As explained above, ring 30 can be installed by bending ring 30 radially upon itself to reduce the diameter. When the bending force is removed, the natural outward bias holds ring 30 within the confines of groove 50. Ring 30 also includes a thickness greater than the depth of groove 50. Thus, when retained in groove 50, a portion of ring 30 remains in the flow path to retain drain element downstream of bore 14 and balance the biasing force provided by resilient element 26.

Housing 12 can be manufactured from any suitable hard material including most grades of corrosion resistant steel. One example method of assembling valve 10 is according to the following general description. Valve seat 24 (shown in FIGS. 4A and 4B) is inserted into valve seat stage 44. The base of seat 24 is prevented from moving farther downstream due to the smaller diameter of downstream stage 44 and shoulder 46. Drain element 22 (shown in FIGS. 3A and 3B) is inserted into inlet section 16 at stage 48 after placing retaining ring 26 into groove 50. Resilient element 26 (shown in FIGS. 1A and 1B) is then inserted between drain element 22 and valve seat 24, prior to inlet section 16 being secured to outlet section 18. Resilient element 26 can optionally be secured to drain element 22 and/or seat 24 via one or more small hooks or similar structures on the appropriate surfaces.

FIG. 3A is a rear perspective schematic of the downstream side of drain element 22 with drain ports 32, drain element recess 36, rear drain isolating structure 52, downstream surface 54, and outer seal 56. FIG. 3B is a plan cross-section of drain element 22 with drain ports 32, recess 36, drain isolating structure 52, downstream surface 54, outer seal 56, and pressure directing surface 58.

FIG. 3A shows the downstream side of drain element 22 with drain ports 32 radially arranged thereon, while the cross-sectional view in FIG. 3B shows two of these ports 32 extending axially through drain element 22. Drain element 22 has a substantially cylindrical body that moves axially through bore 14 (as shown in FIGS. 1A and 1B). When drain element 22 is biased away from seat 24 (shown in FIGS. 4A-4B), ports 32 provide a path for fluids such as unburned fuel to drain from the combustor chambers (not shown) to valve seat port 34, located at the center of seat 24. Ports 32 can also be radially tapered to encourage more liquid to flow toward valve seat port 34. Liquid being drained can also flow along drain isolating structure 52 toward port 34. However, flow is restricted from going around drain element 22 because the cylindrical body is sized and configured to direct flow only through ports 32.

Drain isolating structure 52 engages against corresponding isolation structure 60 on valve seat 24 (shown in FIGS. 4A and 4B) to close the valve. Recall from FIG. 1B that pressure P is directed toward front pressure recess 36 on drain element 22. As seen in FIG. 3B, recess 36 includes pressure directing surface 58. Structures 52 and 60 engage upon sufficient application of combustor pressure P to pressure directing surface 58 in recess 36, closing off access and fluid communication between inlet section 16 and outlet section 18.

Drain ports 32 are small enough in diameter and can also be tapered radially to direct drainage of liquids toward the center line of valve 10 (and valve seat port 34). This shape and size also helps provide sufficient pressure differential to facilitate movement of drain element 22. To further improve liquid drainage and movement of element 22, ports 32 can also have a larger upstream opening and a smaller downstream exit. Movement is also facilitated by seal surface 56. In this example, seal 56 is self-lubricating graphite or other material for simultaneously reducing friction and preventing leakage.

In this example, drain element 22 is manufactured from SAE grade 410 corrosion resistant steel that has been heat treated for hardness. However, other alloys with similar or improved hardness and corrosion resistance can be readily substituted. As noted above, drain element 22 can also be provided with graphite seal 56 or a similar coating around its outer diameter to provide lubrication for axial movement of element 22 in bore 14.

FIG. 4A is a perspective view of fixed valve seat 24 with center drain port 34 and surrounding seat isolation structure 60. FIG. 4B shows a plan cross-section of valve seat 24. As seen in FIG. 1A, excess fuel and other fluids from combustion chambers (not shown) flow through center drain port 34 when valve 10 is open. And as seen in FIG. 1B, valve 10 is sealed by moving drain element 22 toward seat 24 to block drain port 34. Blockage is effected by engaging drain isolation structure 56 (shown in FIG. 3B) with seat isolation structure 58.

Valve seat 24 can be manufactured from any suitable material. In this example, drain element 22 is formed from austenitic low-carbon SAE grade 304L stainless steel. However, other alloys with similar or improved properties, such as SAE grades 321 or 347 can be readily substituted.

This example embodiment of combustor drain valve 10 has been described in the context of a newly assembled combustor. It is apparent that valve 10 can also be readily adapted and used in a replacement or refurbishment capacity, particularly as a substitute and improvement over the aforementioned ball-and-spring valves. The drain valve can also be adapted for several other uses whereby a fluid is to be drained from one or more upstream chambers before the chamber is pressurized and the valve is to be closed.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A drain valve assembly comprising:
a housing including a central bore extending through the housing, the bore having a central flow control segment disposed axially between an inlet fitting segment and an outlet fitting segment;
a seat element having an upstream side, a downstream side, and an outlet port proximate a center of the seat element providing fluid communication therebetween, the seat element fixed in the flow control segment adjacent the outlet fitting segment;
a drain element retained upstream from the fixed seat element and including an upstream side, a downstream side, and a plurality of inlet ports through the drain element providing fluid communication therebetween, the drain element operable between a first axial position closest to the inlet fitting segment, and a second axial position abutting an upstream surface of the fixed seat element, with the first axial position defining an open, flow-permissive configuration for the valve assembly, and the second axial position defining a closed, flow-restrictive configuration for the valve assembly; and
a resilient element disposed axially within a middle fluid chamber defined by a portion of the flow control segment located between the fixed seat element and the movable drain element, the resilient element applying a first biasing force to urge the drain element upstream toward the first position, urging the valve assembly into the open, flow-permissive configuration.

2. The drain valve assembly of claim 1, wherein a first flow isolation structure projects axially either from a downstream surface of the movable drain element or from the upstream surface of the fixed seat element.

3. The drain valve assembly of claim 2, wherein a second flow isolation structure complementary to the first flow isolation structure projects axially from the other of the downstream surface of the movable drain element or the upstream surface of the fixed seat element.

4. The drain valve assembly of claim 3, wherein the drain element is biased into the second axial position, converting the valve assembly into the closed, flow-restrictive configuration by abutting the first isolation structure against the second isolation structure, thereby preventing fluid communication between the inlet port and the outlet port.

5. The drain valve assembly of claim 1, further comprising a retaining ring upstream of the movable drain element to prevent the resilient element from biasing the drain element upstream of the first axial position.

6. The drain valve assembly of claim 5, wherein the retaining ring is secured in a retaining groove formed radially around a portion of the flow control segment.

7. The drain valve assembly of claim 1, further comprising a seal disposed radially between an outer diameter of the movable drain element and the bore.

8. The drain valve assembly of claim 7, wherein the seal is self-lubricating.

9. The drain valve assembly of claim 8, wherein the seal comprises graphite.

10. The drain valve assembly of claim 1, wherein the inlet fitting segment is fluidly connected to at least one combustion chamber of a gas turbine engine.

11. The drain valve assembly of claim 1, wherein the plurality of inlet ports are tapered to direct fluid toward the outlet port on the fixed seat element.

12. The drain valve assembly of claim 1, further comprising a recessed portion on the upstream side of the movable drain element for directing fluid pressure received around the inlet fitting segment into a second biasing force onto the drain element, the second biasing force opposing the biasing force of the resilient element to urge the drain element toward the second axial position and close the valve.

13. A valve drain element comprising:
a substantially cylindrical body configured for axial movement along a valve bore between a first upstream position and a second downstream position, the body including an upstream side, a downstream side, and a plurality of ports providing fluid communication therebetween, the body sized to direct fluid flow exclusively through the plurality of ports instead of around an outer diameter of the drain element;
a bias receiving surface forming a portion of the downstream side of the body, the bias receiving surface configured to axially direct a first applied biasing force urging the drain element toward the first upstream position;
a recessed structure on the upstream side of the body configured to concentrate and direct fluid pressure received from an upstream source into a second biasing force opposing the first biasing force; and
a fluid isolating structure projecting generally perpendicular to the body from the downstream side, the fluid isolating structure configured to abut a second fluid isolating structure when the drain element is in the second downstream position.

14. The drain element of claim 13, further comprising a seal disposed around the outer diameter of the valve element body to block fluid flow around the outer diameter.

15. The drain element of claim 14, wherein the seal comprises graphite.

16. The drain element of claim 13, wherein the plurality of ports is dispersed a substantially equivalent radial distance from a center line of the drain element body.

17. The drain element of claim 16, wherein the plurality of ports each have downstream exits external to the first fluid isolating structure.

18. The drain element of claim 17, wherein the plurality of ports are tapered radially inward toward the blocking structure.

19. The drain element of claim 13, wherein the upstream source is a combustor of a gas turbine engine.

20. The drain element of claim 13, wherein the gas turbine engine is an auxiliary power unit (APU).
